(19) United States
(12) Patent Application Publication
(10) Pub. No.: US 2022/0242556 A1
(43) Pub. Date: Aug. 4, 2022

(54) Increasing Aircraft Parking Capacity at Airports

(71) Applicant: Borealis Technical Limited, North Plains, OR (US)

(72) Inventors: Joseph J. Cox, Portland, OR (US); Isaiah W. Cox, London (GB); Jan Vana, Prague (CZ)

(73) Assignee: Borealis Technical Limited, North Plains, OR (US)

(21) Appl. No.: 17/591,474

(22) Filed: Feb. 2, 2022

Related U.S. Application Data
(60) Provisional application No. 63/144,709, filed on Feb. 2, 2021.

(51) Int. Cl. B64C 25/40; B64F 1/36; B64F 1/305

(52) U.S. Cl. CPC B64C 25/405; B64F 1/305; B64F 1/36

(57) ABSTRACT

A method for increasing airport airside parking locations without adding infrastructure to the airport is provided. Aircraft equipped with pilot-controllable landing gear wheel-mounted electric taxi drive systems for ground travel are maneuvered forward into remote tarmac stands or non-standard parking locations with the electric taxi drive systems, turned 180 degrees through tight turns, and parked in a nose-out orientation that enables the aircraft to efficiently unload and load passengers. The electric taxi drive systems drive the departing aircraft forward out of the parking locations. Remote tarmac parking locations may be located in areas that do not interfere with arrival and departure of aircraft parking at existing terminal stands. The present method may increase aircraft parking capacity at an airport, provide better utilization of existing tarmac space at the airport, reduce requirements for ground personnel on a per-flight basis, and improve airport ground operations efficiency.

### TECHNICAL FIELD

The present invention relates generally to increasing parking capacity and available parking locations for aircraft at airports and, more specifically, increasing airport parking capacity and available parking locations for aircraft when aircraft are maneuvered with electric taxi drive systems into standard and non-standard parking locations without increasing airport infrastructure.

### BACKGROUND OF THE INVENTION

Airports may be designed and constructed with different kinds and numbers of parking locations to accommodate a range of sizes and types of aircraft. At many airports, the majority of parking locations are at gates or stands with passenger loading bridges or jet bridges that provide direct connections between a terminal building and the aircraft. Some airports provide a combination of parking locations with passenger loading bridges and stands that do not have passenger loading bridges. At other airports, there are no passenger loading bridges, and aircraft park at stands that are remote from the terminal building. At most airports, the numbers of standard parking spaces available for aircraft may be limited by many factors, including design of the airport terminal building, airside ramp configurations, and taxiway locations. In addition, airport spacing requirements between aircraft may limit numbers of aircraft that may be parked at gates or stands with passenger loading bridges, as well as at remote stands, and this may limit parking capacity at the airport. Providing sufficient numbers of standard parking locations, even temporary parking locations, for all aircraft using busy airports without expanding airport infrastructure presents challenges.

The use by airports of non-standard or alternate parking arrangements in which aircraft may be parked in areas other than standard ramps or aprons and terminal gates has been addressed in the context of emergency operational situations that are not normally encountered during normal airport operations. For example, aircraft overflow parking has been recently addressed in the context of the current global COVID-19 pandemic, which has presented airport operators with the challenge of finding enough locations to support the temporary parking of aircraft that have been taken out of operation as a result of the worldwide decline in air traffic. Remote and other parking plans developed for this purpose have, understandably, focused on the safe storage and maintenance of the aircraft and tarmac surfaces where they are stored. Aircraft may be temporarily parked in non-standard parking locations, including runways and taxiways. This may present risks to be mitigated, particularly at airports where the runways and taxiways may be in use.

Currently, during both normal and non-normal airport ground operations, arriving aircraft are moved into parking locations with at least one operating main engine or, in some instances, with a tow tractor or tug. Departing aircraft are pushed back out of parking locations with a tug to a location where the aircraft may be moved forward with its main engines. Although aircraft may be able to turn themselves through angles of up to 70-90 degrees, aircraft main engines and tugs cannot be safely used to maneuver aircraft into and out of parking locations that require tight or sharp turns or that position aircraft within defined clearance distances from adjacent aircraft. Even at idle, aircraft main engines produce jet blast that may be damaging. Tugs are not allowed to tow aircraft at angles greater than 40-45 degrees and, therefore, cannot turn an aircraft through any tight or sharp turns that may be required to maneuver an aircraft attached to a tug.

Applicant and others have proposed driving aircraft during ground travel with non-engine electric taxi and other drive systems that do not rely on operation of aircraft main engines and tugs to move aircraft into and out of airport ramp parking locations. Moving aircraft with electric taxi or other drive systems through the tight or sharp turns required to maneuver the aircraft into non-standard and otherwise unusable parking locations remote from or adjacent to an airport to increase airport parking capacity without expanding infrastructure, or for any other reason, has not been suggested.

### SUMMARY OF INVENTION

The present invention provides a method that increases airport parking capacity and creates airport parking locations without increasing airport infrastructure when aircraft are equipped with electric taxi drive systems for ground travel to maneuver the equipped aircraft with tight, sharp turns into and out of the created airport parking locations to maneuver and park within at least minimum clearances from adjacent aircraft and structures.

Another object of the present invention provides a method for increasing airport capacity and creating airport parking locations when aircraft equipped with electric taxi drive systems are maneuvered with the electric taxi drive systems to make tight, sharp turns to drive into and out of parking locations at airports located at remote stands, non-standard parking locations, and tarmac locations considered unusable as aircraft parking locations.

An additional object of the present invention provides a method for maneuvering aircraft equipped with electric taxi drive systems into and out of non-standard and remote parking locations that drives arriving aircraft with the electric taxi drive system in a nose-in orientation into a parking location, sharply turns the aircraft 180 degrees to position the aircraft in a nose-out orientation prior to unloading, and then drives the departing aircraft forward after loading.

A further object of the present invention provides a method that increases numbers of tarmac parking locations at an airport when aircraft equipped to be driven during ground travel with electric taxi drive systems are maneuvered with tight or sharp turns to park in airport tarmac locations not typically used for parking at orientations that enable multiple aircraft to park and maneuver safely out of the tarmac parking locations.

In accordance with the foregoing objects, a method is provided for increasing airport airside parking locations without adding infrastructure to the airport. Aircraft equipped with pilot-controllable landing gear wheel-mounted electric taxi drive systems to power ground travel are maneuvered with the electric taxi drive systems along paths that may have tight, sharp turns to tarmac parking locations. The equipped aircraft are maneuvered within the tarmac parking locations to turn and park with safe clearance from adjacent aircraft in an orientation that enables the aircraft to unload and load passengers and/or cargo and then drive in a forward direction with the electric taxi drive systems out of the tarmac parking location. Tarmac parking locations added to the airport airside area in accordance with the present invention may be located in ramp and other areas that allow aircraft parking at terminal gates and stands to continue to travel into and out of the terminal gates and stands without interference.

In addition to providing better utilization of existing tarmac areas within an airport ramp and increasing parking capacity, the present method may reduce the need for ground personnel on a per-flight basis and may also reduce stoppage and congestion in taxi lanes. Throughput from existing stands may also be increased. Overall airport flow rate and throughput may be increased when landing gear wheel-mounted electric taxi drive system-driven aircraft are able to decrease time spent at gates and stands, and this higher flow rate may add capacity without increasing the number of physical parking locations.

Additional objects and advantages will be apparent from the following description, claims, and drawings.

### BRIEF DESCRIPTION OF THE DRAWINGS

FIG. 1 is a diagram of an aerial view of a portion of an airport terminal building and ramp area showing aircraft parked at passenger loading bridges connected to the terminal building in a nose-in orientation and aircraft parked in a nose-out orientation at ramp tarmac stands remote from the terminal building;

FIG. 2 is a schematic diagram of an airport ramp area adjacent to a terminal building where all aircraft shown are parked at remote tarmac stands in nose-out orientations;

FIG. 3 is a diagram of one exemplary parking orientation in which multiple aircraft may be parked in non-standard parking locations in accordance with the present invention; and

FIG. 4 is a diagram of a second exemplary parking orientation in which multiple aircraft may be parked in non-standard parking locations in accordance with the present invention.

### DESCRIPTION OF THE INVENTION

Many airports around the world are not able to expand their ability to accommodate more aircraft for a number of reasons, including the inability to expand existing infrastructure to provide the parking locations needed for additional aircraft to unload and load passengers and/or cargo and to be serviced during turnaround. Adding gates with passenger loading bridges that connect to airport terminals is not only costly and time consuming, but few airports have the space required to expand capacity in this manner. Airports may use remote stands in ramp area locations that are not directly connected to an airport terminal building. Depending on the distance between the remote stand and the terminal, passengers either walk or are transported between the aircraft and the terminal. As noted above, moving aircraft into and out of remote stands currently requires operation of the aircraft's main engines and/or attachment to a tug. Maneuvering aircraft into and out of gates and stands that are adjacent to or remote from the terminal with either main engines or tugs, requires parking and parked aircraft to be spaced apart by at least distances corresponding to defined jet blast hazard zones. Moreover, the number of aircraft that can be accommodated at remote stands may be limited by the tarmac area available for this purpose within or adjacent to an airport ramp area. The method of the present invention overcomes these challenges and increases numbers of aircraft, specifically aircraft equipped for ground travel with landing gear wheel-mounted electric taxi drive systems controlled by the aircraft pilots, that an airport can accommodate in remote and terminal parking locations without requiring expansion of the airport's physical infrastructure. Numbers of tarmac stands remote from an airport terminal may be increased to accommodate these equipped aircraft. Pilots of the equipped aircraft can control the electric taxi drive systems and maneuver the aircraft with tight or sharp turns into and out of a parking location within an area that is significantly smaller than the area required to move aircraft into and out of parking locations with both main engines and tugs. Further, as described below, the pilot may maneuver an arriving electric taxi drive system-equipped aircraft within a tarmac stand parking location to turn and park in a nose-out orientation so that the parked aircraft is not required to turn at departure and is ready to be driven forward with the electric taxi drive systems.

The terms “airport terminal” and “terminal” used herein include an airport terminal building and like structures, whether or not attached to a terminal building. The terms “parking location,” “gate,” and “stand” all are used to refer to places or locations where aircraft are parked at or near an airport terminal or within an airport ramp area for passenger transfer after arrival and before departure. The terms “ramp” and “ramp area” will be used herein to refer to the airside area at an airport that is intended to accommodate aircraft for the loading and unloading of passengers, mail, cargo, fueling, parking, or maintenance. The term “ramp” is synonymous with the term “apron,” which is also used to identify this area at an airport. “Remote stands” refer to aircraft parking locations that are located, usually on the ramp tarmac, a distance away from the terminal. Passengers may walk or a bus or other vehicle may be provided to transport them between the aircraft and the terminal. Passengers use either the aircraft stairs or portable stairs to transfer into and out of aircraft parked at remote stands. Non-standard parking locations refer to parking locations along taxiways and other airside locations where aircraft parking is not normally permitted.

“Electric taxi drive systems,” “drive systems,” and “electric taxi systems” refer to pilot-controllable landing gear wheel-mounted drive systems used to drive aircraft independently of and without reliance on operation of aircraft main engines and tugs or external tow vehicles. Electric taxi drive systems may include landing gear wheel-mounted electric drive motors, gear or roller traction drive systems, clutches, and other components activatable to power landing gear wheels and drive the aircraft during ground travel in response to pilot control. An example of one type of an electric taxi drive system developed by Applicant to drive an aircraft during ground travel without reliance on operation of the aircraft's main engines and attachment to tugs is described in commonly owned U.S. Pat. No. 10,308,352, the disclosure of which is fully incorporated herein in its entirety by reference. Other drive systems using drive motors that are not electric, including, for example, hydraulic or pneumatic drive motors, may also drive aircraft in connection with the automatic aircraft parking system and method of the present invention and are contemplated to be included within the terms “electric taxi drive systems” and “drive systems.” An electric taxi drive system may be mounted completely within a volume defined by wall sections of a landing gear wheel in one or more nose or main landing gear wheels. In a preferred embodiment, electric taxi drive systems are mounted completely within defined wheel wall section volumes in both nose landing gear wheels and are controlled by a pilot or flight crew from the aircraft cockpit with controls designed to operate the electric taxi drive system, power the nose landing gear wheels, and drive the aircraft during ground travel without reliance on the aircraft's main engines and external assistance from tugs. “Equipped aircraft” are aircraft that are equipped with the foregoing electric taxi drive systems.

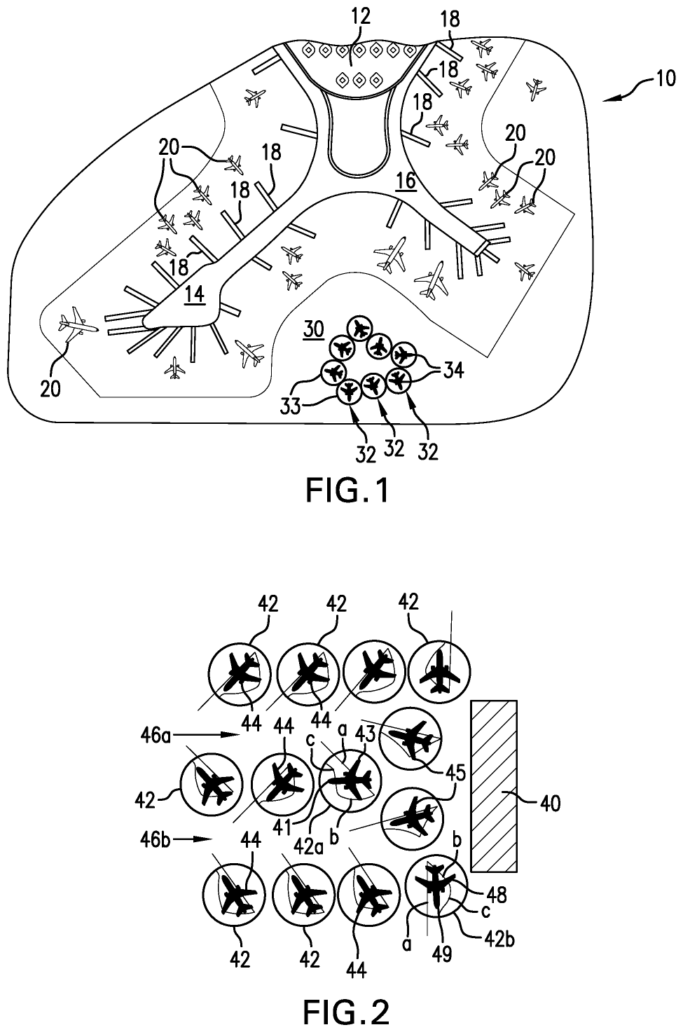

Referring to the drawings, which may not be drawn to scale, FIG. 1 is a diagram showing an aerial view of a portion of an airport 10 with a terminal building section 12 that has two extensions 14 and 16 and a number of spaced passenger loading bridges 18 attached to the terminal building section 12 through the extensions 14 and 16. Aircraft 20 are shown parked at many of the passenger loading bridges 18. The configuration of the terminal building section 12 and the extensions 14 and 16 may be designed to maximize the numbers of spaced passenger loading bridges that may be connected between aircraft 20 and the terminal. While it might be theoretically possible to decrease spacing between passenger loading bridges 18 so that additional passenger loading bridges 18 may be added to the terminal section 12 or the extensions 14 and 16, actually accomplishing that might not be feasible. Depending, for example, on the sizes of the aircraft 20 to be parked at the existing passenger loading bridges 18, the number of additional aircraft that may be accommodated by adding passenger loading bridges is likely to be limited and cost prohibitive.

Parking locations for additional aircraft may be added in accordance with the present method without increasing numbers of passenger loading bridges or adding any additional physical infrastructure to the airport 10. As shown in FIG. 1, additional parking locations for aircraft may be added, for example to a section of ramp area tarmac 30 located remotely from the terminal 12 and from extensions 14 and 16. The ramp area 30 may accommodate a number of remote stands 32 that, advantageously, are positioned to park a maximum number of aircraft without interfering with the ramp travel paths or taxi lines (not shown) of arriving and departing aircraft 20 into and out of parking locations at the passenger loading bridges 18. The number of remote stands 32 and the arrangement of the aircraft 34 parked at the remote stands shown in FIG. 1 is an example of only one possible arrangement of aircraft that may be parked at a remote ramp tarmac stand in accordance with the present invention. The orientation of the parked aircraft 34, which are all equipped with pilot-controllable landing gear wheel-mounted electric taxi drive systems for ground travel, is shown to be nose out from a center of the cluster arrangement of the aircraft 34, as shown. A pilot drives each aircraft 34 forward in a nose-in orientation to a remote stand 32 and then maneuvers the aircraft with the electric taxi drive systems through tight and sharp turns within an area at each stand 32 represented by a circle 33 to park nose-out from the center. This nose-out orientation enables the aircraft 34 to be driven forward out of the remote stand parking locations.

FIG. 2 is a schematic diagram of another possible arrangement of remote stand parking locations in a ramp area adjacent to an airport terminal that is different from the arrangement shown in FIG. 1. Other arrangements and numbers of aircraft and ramp area tarmac remote stands and parking locations are also contemplated to be within the scope of the present invention. In the arrangement shown in FIG. 2, a terminal building is represented at 40. As may be the situation in a number of airports around the world, all of the aircraft parking locations are remote from the terminal 40, and passenger loading bridges or other direct connections between parked aircraft and the terminal building are not available. The arrangement of the remote parking stands, represented by the circles 42, may vary from what is shown and may be determined by, for example, the numbers and sizes of aircraft (43, 44, 45, and 48) to be parked and accommodated by the airport. The spacing of the remote stands 42 and the orientations of the parked aircraft 44 may be selected to provide at least minimum spacing and clearances between adjacent stands to permit adjacent aircraft to be maneuvered safely, as described herein, within each stand's area and also to permit aircraft closer to the terminal, such as aircraft 45, to depart and be maneuvered with the electric taxi drive systems to drive away from the terminal upon departure without interference with other parked aircraft 44. Defined travel lanes, such as lanes 46a and 46b, may be provided to ensure that the adequate clearance between moving, parking, and parked aircraft, for example between the moving departing aircraft 45, the parking aircraft 43, and the parked aircraft 44, is maintained as the moving aircraft are driven forward away from the terminal 40.

Although not shown in either FIG. 1 or FIG. 2, markings on the ramp tarmac surface may be provided to designate the locations of each of the remote stands 32 and 42, the locations of the defined travel lanes 46, and any other information helpful to pilot maneuvering the electric taxi drive systems to park the aircraft 34 and 44 within assigned remote stands. A specific color not otherwise used for tarmac markings and information may be designated to communicate location and other information only for the remote parking stands.

It has been discovered that aircraft equipped with nose landing gear wheel-mounted electric taxi drive systems may be controlled by a pilot driving the aircraft with the electric taxi drive systems to maneuver the aircraft very precisely through tight and sharp turns, and this enables the pilot to turn the aircraft within a relatively small area and still maintain required clearances between aircraft. This should permit airports to maximize the number of remote stands that may fit within a ramp or other airport area. In addition, the same number of stands can support more throughput when aircraft may be maneuvered with precision into and out of parking locations as described herein. The time required for aircraft to leave a stand is much less when the aircraft has turned and parked nose-out upon arrival than if the aircraft must turn from a nose-in orientation to a nose-out orientation before departure. Blockages of taxiways may also be avoided when aircraft do not need to stop and turn to change directions. As described, the equipped aircraft are driven in only a forward direction and do not need to be driven in reverse with the electric taxi drive systems to leave a parking location, which may shorten the departure process. When departing aircraft do not need to be pushed back out of the described tarmac parking locations, numbers of pushed back aircraft stopped on the airport taxiways may be reduced or even eliminated, and only moving aircraft may be present on the taxiways.

The circles 33 and 42 in FIGS. 1 and 2 represent the relatively small areas within which the equipped aircraft 34, 43, 44, 45, and 48 are turned to park at each remote tarmac parking location or stand area. Aircraft 43 and 48 in FIG. 2 illustrate aircraft turning maneuvers in accordance with the present method that enable aircraft pilots to drive the aircraft with the electric taxi drive systems into and out of the remote stands shown in FIGS. 1 and 2. Aircraft 43 is shown in the process of maneuvering within the remote stand area represented by circle 42a prior to parking. The aircraft 43 is in the process of turning, as described below, so that the nose end 41 will be oriented in a direction that will facilitate departure from the stand 42a. Aircraft 48 is shown parked at the remote stand represented by circle 42b adjacent to the terminal 40. The nose end 49 of the aircraft 48 is oriented in a direction relative to the terminal 40 and adjacent aircraft 44 and 45 that will enable the pilot to control the electric taxi drive systems and safely drive aircraft 48 in a forward direction away from the terminal 40 without compromising required clearances between adjacent aircraft or the terminal or creating interference between adjacent aircraft. When aircraft 43 has turned 180 degrees, the nose end 41 will be oriented toward the travel lane 46a, and the pilot can drive the aircraft 43 with the electric taxi drive systems forward along travel lane 46a away from the terminal 40.

The lines a, b, and c near aircraft 43 and 48 within the circles 42a and 42b define the aircraft travel path into the remote stand. These lines (not labeled) are shown in each of the circles 42 representing the remote stands. The equipped aircraft 43 has entered the circle 42a along the line a, and the pilot has maneuvered the aircraft with its electric taxi drive systems to make the tight, sharp turn required to follow the path of line b, and is in the process of turning the aircraft with the electric taxi drive systems, less sharply, along line c so that the nose 41 of the aircraft 43 will be oriented along line a toward the travel lane 46a when the aircraft 43 is parked. When the aircraft 43 is ready for departure, the pilot will drive the aircraft forward to leave the remote stand and away from the terminal 40 along the travel lane 46a. The aircraft 48 also enters the remote stand, represented by the circle 42b, in a nose-in orientation along the path of the line a, shown substantially parallel to the terminal 40, with the nose 49 directed toward adjacent aircraft 45. The pilot drives the equipped aircraft 48 with its electric taxi drive systems to make the tight, sharp turn that follows the path of line b, at an angle to path a, and then to turn less sharply to drive aircraft 48 along the path labeled c and park in the nose-out position shown in FIG. 2, which is 180 degrees from the nose-in orientation of the aircraft 48 as it entered the stand 42. When the aircraft 43 and 48 are parked, they may then unload arriving passengers and/or cargo, be serviced, load departing passengers and/or cargo. Pilots of these aircraft may then drive them with the electric taxi drive systems in only a forward direction of their respective remote stands 42a and 42b away from the terminal 40 and out of the ramp to takeoff. All of the electric taxi drive system-driven aircraft maneuvers described take place within the remote stands.

The foregoing taxi-in procedure allows inbound electric taxi system-driven aircraft to make the tight, sharp turns described at a time when the aircraft is lighter after landing than when it is fully loaded before takeoff. Loads on the landing gear, wheel, and tires will be reduced when a sharp turn is made by an arriving parking aircraft that is at its lightest compared to loads on the landing gear, wheel, and tires of an aircraft loaded with passenger, cargo, and fuel for a departing flight. In addition, turning a lighter aircraft may consume less energy.

When arriving electric taxi drive system-driven aircraft may be maneuvered into and within remote tarmac stands as described herein to park in the nose-out orientations shown in FIGS. 1 and 2, the aircraft front doors, which may be the main doors used for passenger transfer, can be accessed more easily by vehicles transporting passengers between the aircraft and the terminal. There may be more clearance space for buses, coaches, and other passenger transport vehicles to pull directly up to the front or nose end of the aircraft, instead of along the side of the aircraft, and then stay in front of the aircraft during passenger transfer. Passengers will have to walk only a relatively short distance between the aircraft front door stairs to the transport vehicle. Currently, it is necessary for passenger transport vehicles to drive through airport traffic and around an aircraft's wing to reach the front of remotely parked aircraft. Passenger transport vehicles can more easily and directly reach the nose end of aircraft parked in remote parking locations in accordance with the present invention. As a result, ground traffic congestion is reduced, there is a lower collision risk than with current procedures, and time for passenger transport and transfer may be decreased. There is, in addition, no risk to passengers and airport ground personnel from operating aircraft engines during passenger transfer from aircraft parked in remote stands with electric taxi drive systems as described herein. Further, because the aircraft main engines are not operating, jet blast hazard zones to be avoided by passengers, ground personnel, and transport vehicles do not have to be marked in these remote stands and aircraft parking locations.

The use of remote tarmac parking stands where aircraft may be driven by pilots controlling electric taxi drive systems to make the described tight, sharp turns and then parked in nose-out orientations upon arrival may increase the speed of ground operations and may, in addition, reduce the need for ground personnel previously needed to direct aircraft into and out of remote tarmac parking stands. Aircraft pilots control aircraft ground movements into, within, and out of the remote parking stands with the aircraft's electric taxi drive systems. Advantageously, the present method positions arriving aircraft in a nose out orientation when they are parked so they are ready to head forward out of the remote stands at departure. No pushback clearance is required at departure because the aircraft are driven in only a forward direction with the electric taxi drive systems. This also eliminates the requirement for wing walkers, who are not needed when all aircraft movements are in a forward direction. As indicated, pilots control the electric taxi drive systems to drive departing aircraft in only a forward direction out of the remote stands. The elimination of the need to request pushback clearance also eliminates the requirement for extra Air Traffic Control and other personnel, which reduces time needed for aircraft driven by electric taxi drive systems to depart stands and travel to taxiways and runways. Wing walkers or other ground personnel may still be used upon arrival of equipped aircraft at the remote stands to provide guidance while aircraft are making the tight, sharp turns required to turn 180 degrees within the remote stand. Aircraft equipped with electric taxi drive systems may also be equipped with on-aircraft monitoring systems that monitor aircraft ground movement. These on-aircraft monitoring systems, which may employ scanning devices, cameras, and/or other monitoring devices, may be used to guide the pilot to make the tight, sharp turns required to park the aircraft in the nose-out orientation shown. Turning guidance may also be provided by lines painted on the tarmac, as noted above, by on-aircraft exterior monitoring systems, or by ramp monitoring systems.

When arriving aircraft are turned 180 degrees within remote stand parking locations prior to unloading, forward taxi-out of the aircraft upon departure may reduce ramp congestion. Once the aircraft is driven forward with the electric taxi drive systems out of the remote stand, the aircraft will always be moving or rolling since there should be no need to stop and change direction. Engines may be started while the aircraft is simultaneously driven by the electric taxi drive systems. Depending on the location of a remote parking stand, engine start for a departing aircraft may occur at any time when there is no danger from jet blast. A departing aircraft's engines may also be started earlier than is usually the case, in the event of inclement weather, for example.

The present method may, in addition, maximize stamina of the electric taxi drive systems, which are operated to drive arriving aircraft into the ramp area and into a parking stand. Using the electric taxi drive systems to turn an arriving aircraft 180 degrees through tight, sharp turns as described when the aircraft is lighter than it will be before departure and while the electric taxi drive systems are warmed up is more efficient than turning a departing aircraft with a cold electric taxi drive system. The electric taxi drive system on the arrived and parked aircraft will be able to cool down during passenger and/or cargo unloading and loading so that, upon departure, the aircraft will start out with a cooled down electric taxi drive system that may be able to drive forward for a longer distance than it might otherwise. Stamina of the electric taxi drive systems may be maximized during both incoming and outgoing operation to drive aircraft into and out parking locations as described herein.

An additional advantage that may accompany implementation of the present method is faster turnaround and better on-time arrival and departure times. As discussed herein, there are benefits to turning an inbound aircraft 180 degrees upon arrival so that is ready to pull forward out of its parking location at departure. In addition, there may be more unknowns requiring time to address and resolve for an outbound departing aircraft than for an inbound arriving aircraft.

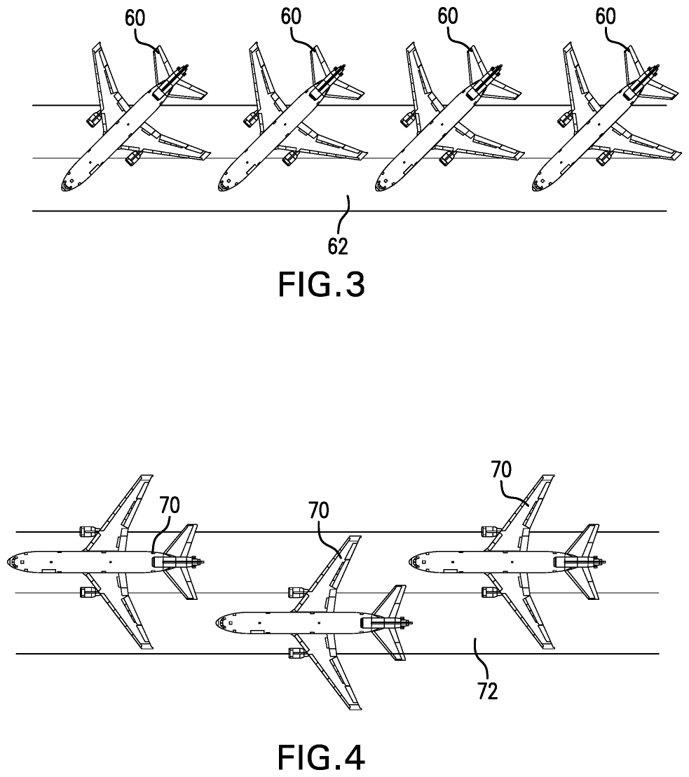

FIGS. 3 and 4 illustrate two different exemplary parking orientations in which multiple aircraft may be parked in non-standard parking locations in accordance with the present invention. Both orientations show the multiple aircraft parked linearly in a non-standard parking location such as, for example, along a taxiway or at the edge of a ramp area adjacent to a taxiway. These orientations may require more tarmac space to accommodate the same number of parked aircraft than the arrangements shown in FIGS. 1 and 2. FIG. 3 shows a number of aircraft 60 parked diagonally on a tarmac space 62 with suitable clearances between adjacent aircraft. FIG. 4 shows a number of aircraft 70 parked in a staggered nose-to-tail arrangement on a tarmac surface 72; the clearances shown are not to scale and would actually be greater to enable the aircraft to maneuver into a parking location and turn, as described in connection with FIGS. 1 and 2. In both arrangements, each aircraft 60 and 70 may be driven with pilot-controlled electric taxi drive systems nose-in to a parking location, turned 180 degrees as shown in FIG. 2, and parked with the nose oriented as shown. To leave the parking location, the aircraft 60 and 70 will be driven forward with the electric taxi drive systems as discussed herein. The orientations, arrangements, and numbers of aircraft shown in FIGS. 1,2, 3, and 4 are meant to be illustrative examples of remote stand and non-standard parking arrangements that may be used to park aircraft driven by electric taxi drive systems that are capable of maneuvering 180 degrees through the tight, sharp turns shown and described to turn and park on arrival so that all subsequent aircraft movements are in a forward direction.

The method of the present invention allows an airport to evaluate and more efficiently use available tarmac space to create remote parking stands and non-standard parking locations for aircraft equipped with landing gear wheel-mounted electric taxi drive systems controllable by pilots to maneuver the aircraft through the tight, sharp turns required to turn the aircraft 180 degrees within these parking stands or locations and achieve the advantages described above. Unused tarmac space that is suitable for this purpose may be optimized for parking additional numbers of aircraft that cannot be accommodated at available parking locations, and unused areas at airports may be filled in with parking for electric taxi drive system-driven aircraft. Moreover, this increased airport capacity may be achieved without adding physical infrastructure. Increasing airport parking capacity as described herein may be an attractive, easily adopted option for airports that are otherwise unable to expand.

While the present invention has been described with respect to preferred embodiments, this is not intended to be limiting, and other arrangements, methods, and structures that perform the required functions are contemplated to be within the scope of the present invention.

### INDUSTRIAL APPLICABILITY

The method of the present invention will have its primary applicability where it is desired to increase airport parking capacity without adding physical infrastructure when aircraft driven by pilot-controlled landing gear wheel-mounted electric taxi drive systems are able to maneuver through tight, sharp turns to be optimally positioned in orientations at remote parking stand and non-standard parking locations that facilitate passenger and cargo transfer and enable departing aircraft to be driven forward efficiently and safely with the electric taxi drive systems.

1. A method that increases airport parking capacity and creates airport parking locations without adding airport infrastructure, comprising:
a. providing an airport with an airside ramp area having a terminal building and a ramp tarmac area adjacent to the terminal building, providing a plurality of tarmac parking stands, each having a defined area, remote from the terminal building, and arranging the plurality of remote tarmac parking stands within a tarmac area sized to accommodate a plurality of adjacent aircraft parked in an arrangement of adjacent remote tarmac parking stands;
b. providing a plurality of aircraft to park within the defined areas of the plurality of remote tarmac parking stands, each of the plurality of aircraft being equipped with landing gear wheel-mounted electric taxi drive systems controllable by a pilot of the aircraft to maneuver the aircraft during ground travel and parking;
c. driving each arriving equipped aircraft with the electric taxi drive systems forward in a nose-in orientation to enter the defined area of a remote tarmac parking stands, maneuvering the equipped aircraft with the electric taxi drive systems completely within the defined area of the remote tarmac parking stand to turn the aircraft 180 degrees, and parking the equipped aircraft within the defined area in a nose-out orientation ready for departure; and
d. unloading and loading the parked equipped aircraft and then driving departing equipped aircraft in the nose-out orientation forward out of the remote tarmac parking stand defined area with the electric taxi drive systems.

2. The method of claim 1, further comprising driving additional arriving equipped aircraft in the plurality of equipped aircraft with the electric taxi drive systems forward in nose-in orientations to enter defined areas of adjacent remote tarmac parking stands, maneuvering the additional equipped aircraft with the electric taxi drive systems to turn 180 degrees completely within the defined areas of the adjacent remote tarmac parking stands, and parking the additional equipped aircraft within the adjacent defined areas in the nose-out orientation ready for departure.

3. The method of claim 2, further comprising, after unloading and loading the additional parked equipped aircraft, driving additional departing equipped aircraft in the nose-out orientations forward out of the remote tarmac parking stand defined areas with the electric taxi drive systems, and avoiding interference with adjacent additional equipped aircraft being driven forward out of defined areas of adjacent remote tarmac parking stands to taxiways.

4. The method of claim 1, further comprising driving the arriving equipped aircraft with the electric taxi drive systems during taxi-in and arriving at a remote tarmac parking stand defined area with warmed up the electric taxi drive systems, and maneuvering the equipped aircraft with the warmed-up electric taxi drive systems completely within the defined area to turn the aircraft 180 degrees and to park the aircraft in the nose-out orientation.

5. The method of claim 4, further comprising inactivating the electric taxi drive systems during aircraft unloading and loading, activating the electric taxi drive systems, and driving the departing equipped aircraft with the activated electric taxi drive systems forward in the nose-out orientation out of the remote tarmac parking stand defined area to a taxiway.

6. The method of claim 1, further comprising providing the plurality of parking stands in an unused airport airside tarmac area remote from a terminal building and spacing the defined areas of the plurality of parking stands within the unused airside tarmac area to accommodate the plurality of aircraft turning completely within the remote tarmac parking stand defined areas from a nose-in to a nose-out orientation.

7. The method of claim 1, further comprising providing passenger loading bridges connected to a terminal building for parking additional aircraft, and arranging the defined areas of the plurality of remote tarmac parking stands within an unused tarmac space remote from the terminal building that avoids interference between the additional aircraft parking at the passenger loading bridges and the aircraft driven forward with the electric taxi drive systems out of the defined areas of the plurality of remote tarmac parking stands.

8. The method of claim 6, further comprising arranging the plurality of parking stands in a circumferential arrangement around a central space, and maneuvering each of the plurality of aircraft within a plurality of defined areas in the circumferential arrangement to turn and park completely within a defined area with a nose of each of the aircraft oriented outwardly of the central space and a tail of each of the aircraft oriented toward the central space.

9. The method of claim 1, further comprising defining a plurality of remote tarmac stands adjacent to a terminal building, wherein the plurality of remote tarmac stands comprises an arrangement of a row of first defined areas positioned substantially parallel to the terminal building and multiple rows of second defined areas positioned perpendicular to the row of first defined areas, each of the multiple rows of defined areas being spaced apart by a travel lane, and wherein each of the plurality of parked equipped aircraft is parked in a nose-out orientation that permits each equipped aircraft to be driven with the electric taxi drive systems forward out of a defined area without risk of interference or collision with other equipped aircraft being driven out of defined areas.

10. The method of claim 1, further comprising defining a plurality of remote tarmac stands or non-standard tarmac parking locations at an edge of the ramp tarmac area or at an edge of a taxiway.

11. The method of claim 10, wherein the plurality of remote tarmac stands or non-standard tarmac parking locations comprises a linear arrangement of aircraft parking locations and each of a plurality of equipped aircraft is turned with the electric taxi drive systems completely within a defined area at a parking location and parked in a diagonal orientation linearly spaced from adjacent ones of the plurality of aircraft.

12. The method of claim 10, wherein the plurality of remote tarmac stands or non-standard tarmac parking locations comprises a linear arrangement of aircraft parking locations and each of the plurality of equipped aircraft is turned with the electric taxi drive systems completely within a defined area at a parking location and parked in a head-to-tail orientation linearly spaced and offset from adjacent ones of the plurality of aircraft.

13. The method of claim 1, further comprising driving an equipped aircraft with the electric taxi drive systems into a defined space at a remote tarmac parking stand in a nose-in orientation to enter the defined space along a linear path, and completely within the defined space, turning a nose end of the equipped aircraft with the electric taxi drive systems at a first angle and direction away from the linear path, further turning the nose end of the equipped aircraft with the electric taxi drive systems at a second angle different from the first angle and in a second direction toward the linear path, and maneuvering the equipped aircraft with the electric taxi drive systems to park along the linear path in a nose-out orientation with the nose end oriented 180 degrees from the equipped aircraft's nose-in orientation.

14. The method of claim 13, further comprising arranging the defined areas of the plurality of remote tarmac parking stands so that the plurality of adjacent equipped aircraft parking in adjacent remote tarmac parking stands are maneuvered with the electric taxi drive systems into and out of adjacent defined areas along linear paths oriented to facilitate forward movement of each of the plurality of adjacent equipped aircraft.

15. The method of claim 14, further comprising arranging and spacing the defined areas to provide travel paths between the defined areas.

16. A method that expands airport parking capacity without adding physical infrastructure, comprising:
a. identifying tarmac areas within an airport airside area remote from a terminal building having sizes capable of accommodating adjacent remote stands for a number of parked aircraft, the number of parked aircraft comprising aircraft equipped with landing gear wheel-mounted electric taxi drive systems controllable to move the equipped aircraft during ground movement;
b. providing a remote stand for each the number of aircraft to be parked in the identified tarmac areas and positioning the remote stands in an arrangement that enables aircraft to enter, maneuver within, and leave the remote stand without risk of collision with aircraft entering or leaving adjacent stands;
c. defining an area for each remote stand sized to allow an equipped aircraft to be driven into, maneuvered completely within, parked, and driven out of the defined area with the electric taxi drive systems;
d. driving an arriving equipped aircraft with the electric taxi drive systems into each remote stand, entering the remote stand defined area along a linear path in a nose-in orientation, maneuvering and turning the equipped aircraft with the electric taxi drive systems 180 degrees completely within the defined area, and parking the aircraft along the linear path in a nose-out orientation to fill each adjacent remote stand with a parked equipped aircraft, wherein adjacent equipped aircraft are parked in nose-out orientations that minimize interference with other adjacent aircraft; and
e. upon departure, driving an equipped aircraft parked in one nose-out orientation forward with the electric taxi drive systems to leave the remote stand defined area without interference with adjacent equipped aircraft parked in a different nose-out orientation.
